(19) United States
(12) Patent Application Publication
(10) Pub. No.: US 2010/0273269 A1
(43) Pub. Date: Oct. 28, 2010

(54) METHOD OF MEASURING MOLECULES IN A FLUID USING LABEL PARTICLES

(75) Inventors: Petrus Johannes Wilhelmus Van Lankvelt, Boekel (NL); Jeroen Hans Nieuwenhuis, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,180

(22) PCT Filed: Nov. 28, 2008
(86) PCT No.: PCT/IB2008/054999

§ 371 Date: Jun. 4, 2010

(30) Foreign Application Priority Data
Dec. 4, 2007 (EP) 07122215.2

(51) Int. Cl. G01N 27/00; G01N 21/75

(52) U.S. Cl. 436/149; 436/164

(57) ABSTRACT

The present invention provides a method of measuring the concentration of molecules in a sample fluid or analyte. Said method comprises the step of mixing the fluid with label particles within a cartridge, wherein the label particles are adapted to capture said molecules and to bind to a sensor surface of said cartridge. Then, the label particles are sedimented towards the sensor surface and the amount of label particles close to the sensor surface is measured. Subsequently, the label particles, which are not bound to the surface, are removed in a “washing” step and finally the amount of label particles close to the sensor surface is measured again.

### FIELD OF THE INVENTION

The invention relates to an improved method of measuring the concentration of molecules in a fluid using label particles.

### BACKGROUND OF THE INVENTION

Biosensing, i.e. the determination of the amount of a specific molecule within an analyte, is receiving increasing interest. Usually the amount of analyte and, in particular, of the molecules of interest is extremely small. Therefore, label particles are used in order to visualize these molecules. For example, WO 2005/010543 A1 and WO 2005/010542 A2 describe biosensors based on the magnetic detection of super-paramagnetic beads present at a sensor surface. Only, if the specific molecules of interest are present, the label beads bind to said sensor surface. Thus, the amount of bound label beads is connected to the amount of specific molecules in the analyte.

These label particles may be supplied in solution or in dry form. The outcome of an experiment like an immuno-assay is strongly dependent on the number of label particles or beads involved in the different assay steps like inhibition and/or binding. More or less beads, for example, during the inhibition step do affect the sensitivity of the measurement (more or less available antibodies). Another example is the effect of more or less beads during the binding step, which results of course in an increased or decreased number of possible bindings. For example, an end-point signal can be achieved with less beads that have good binding possibilities (in case of an inhibition assay: low target concentration) or with a high number of beads with less binding possibilities (in case of an inhibition assay: high target concentration). This shows that when the involved bead concentration is unknown, signals can be measured with similar values, but still have different target concentrations.

However, it may be difficult to properly control the amount of label particles being present for binding. For example, if the particles are supplied in dry form, not all of them might redisperse until the assay starts.

### SUMMARY OF THE INVENTION

It is therefore an object of the present invention to overcome this drawback and to provide an improved method of measuring the concentration of molecules within an analyte or sample fluid.

The present invention is based on the idea to measure the actual number of label particles present or available within the sample volume or cartridge. This is achieved by measuring the amount of particles close to the sensor surface at least twice: In one measurement only the bound particles are detected (as is commonly done). In a second measurement all particles are detected.

Thus, the present invention provides a method of measuring the concentration of predetermined molecules in a sample fluid or analyte. Said method comprises the step of adding the sample fluid to a cartridge with label particles, wherein the label particles are adapted to capture said predetermined molecules and to bind to a sensor surface of said cartridge. Then, the label particles are allowed to interact with the sensor surface and the amount of label particles close to the sensor surface is measured. Subsequently, the label particles, which are not bound to the surface, are removed in a “washing” step and finally the amount of label particles close to the sensor surface is measured again. Preferably, the method further comprises the step of processing the results of the measuring steps and calculating the concentration of the predetermined molecules in the sample fluid.

Using the result of the two measurements one may calculate the amount of bound and unbound label particles (as well as the total amount of label particles). This allows access to important parameters for the experiment, e.g., the immuno-assay, which are necessary to correctly calculate the concentration of the molecules to be detected.

The described method may be implemented into different known techniques to perform bio-sensing. For instance, the amount of label particles close to the sensor surface may be measured by frustrated total internal reflection (FTIR). Alternatively, the amount of label particles close to the sensor surface may be measured by measuring the magnetic stray field of the label particles with a magneto-resistive sensor. However, the method according to the present invention is not limited to any specific sensing technique or sensor. The sensor can be any suitable sensor to detect the presence of (magnetic) particles on or near to a sensor surface, based on any property of the particles, e.g., it can detect via magnetic methods (e.g. magneto-resistive, Hall, coils), optical methods (e.g. imaging, fluorescence, chemi-luminescence, absorption, scattering, evanescent field techniques, surface plasmon resonance, Raman, etc.), sonic detection (e.g. surface acoustic wave, bulk acoustic wave, cantilever, quartz crystal, etc), electrical detection (e.g. conduction, impedance, amperometric, redox cycling), combinations thereof, etc.

In general, it is preferable if the label particles are super-paramagnetic. In that case, the label particles may be actuated towards the sensor surface by magnetic actuation. Furthermore, the “washing” step, namely the removal of unbound label particles from the sensor surface may be achieved by using a magnetic field as well.

Of course, the present invention may be generalized to large-scale or array experiments by repeating the step of measuring the amount of particles at several specific binding spots of the sensor surface. This may as well be done simultaneously for several binding spots. These binding spots may contain different binding or capture molecules in order to perform a large number of different experiments within the same assay.

Depending on the assay, the label particles may bind to the sensor surface only, if the molecules to be detected are being captured. Vice versa, in an inhibition assay the label particles may bind to the sensor surface only, if no molecules are being captured. In general, the method according to the present invention can be used with several biochemical assay types, e.g. binding/unbinding assay, sandwich assay, competition assay, displacement assay, enzymatic assay, etc.

These and other aspects of the invention will be apparent from and elucidated with reference to the embodiment(s) described hereinafter.

### BRIEF DESCRIPTION OF THE DRAWINGS

FIG. 1 schematically shows the principle of FTIR.

FIG. 2 depicts a diagram showing the result of a measurement according to the present invention.

### DETAILED DESCRIPTION OF EMBODIMENTS

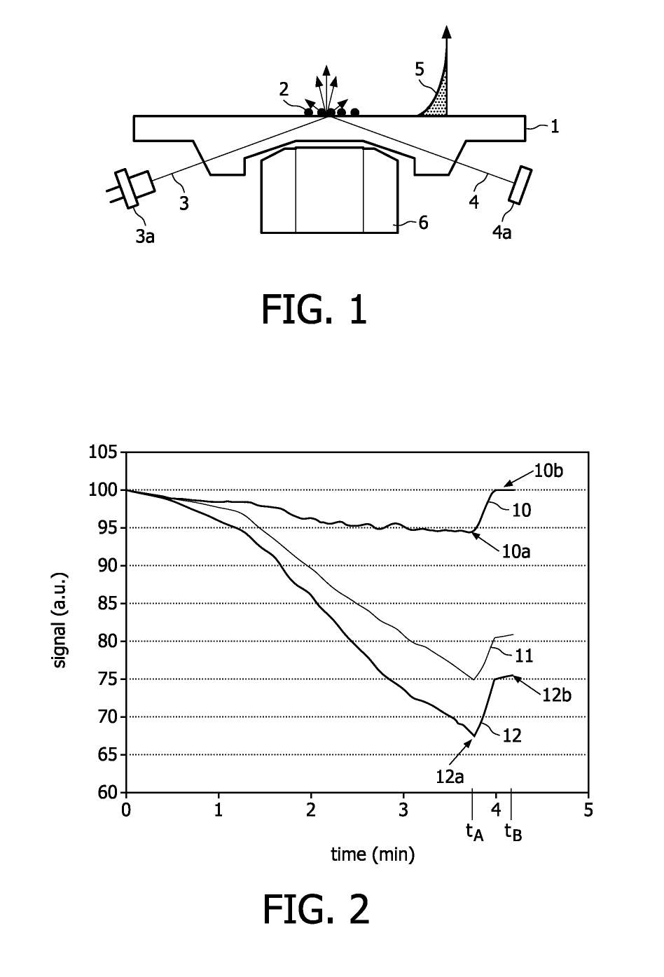

FIG. 1 schematically shows the functional principle of FTIR. Label particles 2 are provided within a cartridge 7. Said cartridge 7 has a sensor surface 1, which is illuminated with a laser or LED 3a. The light is reflected at the sensor surface 1 and detected by a detector 4a, which may be, e.g., a photo diode or a CCD camera. The optical path 3 of incoming light is chosen such that the condition of total internal reflection is fulfilled. In that case, an evanescent optical field 5 with a typical evanescent decay length of 100 nm to 1000 nm is generated. Thus, only if label particles 2 are sufficiently close to the sensor surface 1, light is scattered at these particles as indicated by the arrows and the evanescent field is disturbed leading to a decrease of intensity of the reflected light.

Once a (sample) liquid is supplied to the sensor surface 1 or to a (cartridge) volume adjacent said sensor surface 1, the label particles 2, which have been supplied in a dry form before, redisperse into solution. Once the particles 2, which are preferably super-paramagnetic, are completely dispersed, they may be accelerated towards sensor surface 1 using magnet 6, where they may bind to the surface if the specific molecule to be detected is present in the liquid sample. For this purpose, specific binding sites may be provided on the sensor surface. After a sufficient amount of time for binding the unbound particles are removed from the sensor surface 1 in a “washing” step. Preferably, this is achieved by a magnetic field generated by a second magnet (not shown). In a common FTIR measurement, the amount of particles bound to the sensor surface (or the binding sites thereof) is then measured after said washing step. Due to the presence of the particles on the sensor surface a portion of the incoming light 3 is scattered at the sensor surface (more particularly, at the bound particles) leading to a decreased intensity in reflected light at detector 4a. Thus, measuring the intensity decrease allows for an estimate of the amount of bound particles.

However, according to the present invention, a measurement before washing is performed as well as will be described with reference to FIG. 2.

FIG. 2 depicts a diagram showing the outcome of such an FTIR measurement according to the present invention. Therein, the intensity of the reflected light is shown in arbitrary units versus time. The three curves correspond to no binding (10), medium binding (11) and high binding (12). All curves start at 100 for t=0, i.e. at the beginning of the assay, where no particles are present at the sensor surface. Thus, a signal of 100 corresponds to total internal reflection without any frustration due to particles.

Subsequently, the particles are attracted towards the sensor surface by a magnet for about 220 seconds. Thus, particles come close to the sensor surface and cause a decrease of the intensity of reflected light. The particles are attracted towards the surface in a pulsed manner, so typically they are pulled towards the surface during the time the magnetic field is switched on and upon switching off the magnetic field they tend to diffuse into the bulk again. Therefore, their average residence time in the evanescent field is quite low for unbound particles, leading to a fairly low signal contribution. However, some of the particles can bind when they get in contact with the surface and these particles remain at the surface. These bound particles are fixed at the surface and therefore they continually interact with the evanescent field, leading to a much higher signal contribution than the unbound particles.

In the case of evanescent wave detection as employed here the signal difference between bound and unbound particles is quite high, because the probing depth of the evanescent field is so small (in the order of 50-150 nm). Only a slight movement of the particles into the bulk already makes them invisible to the FTIR sensor. When other sensor principles are employed with a larger sensing depth this effect is less apparent, and the signal contribution of unbound particles will be much more similar.

During the initial phase of the experiment ever more particles are collected near the surface. This can be clearly seen in sensor signal 10, where no binding takes place. After about 2 minutes most particles have been collected and signal 10 stays flat. For the other curves 11 and 12 the collection process of particles takes place in parallel with the binding process. The difference between signal 10 and the other curves is due to the signal contribution of bound particles. Since ever more particles are collected near the surface during the initial phase of the experiment, the speed of the binding process will initially increase. After about 2 minutes all particles have been collected near the surface and the binding rate is fairly constant. It can be clearly seen that the average signal contribution of the bound particles is substantially higher than the signal contribution from the unbound particles.

After the particles are given a sufficient amount of time to bind to the sensor surface a second magnet is used to remove the super-paramagnetic particles, which are not bound, from the sensor surface. In FIG. 2, this happens after about t_{A}=220 seconds leading to a steep increase in the signal of reflected light intensity, since some of the particles causing a frustration of the total internal reflection are removed from the sensor surface. When all un-bound particles are removed the curves saturate at time t_{B}.

In case of no binding, as shown by curve 10, the signal obviously saturates (10b) at the primal value of 100, since all particles attracted to the surface by magnetic field are again removed by magnetic field. However, if binding takes place, as indicated by curves 11 and 12, the primal value is not met again, since in this case some of the particles attracted towards the sensor surface are bound to it and thus remain there. The more binding the smaller the final signal at t_{B}.

From the signal of reflected intensity at times t_{A} and t_{B} one gains information about the total number of particles x+y at the sensor surface and the number of bound particles y, respectively. It should be taken into account that the signal contribution of the unbound particles is much lower than the signal contribution of the bound particles, because the average residence time of an unbound particle in the sensitive region of the sensor is substantially lower than for a bound particle. Therefore one should take into account a correction factor to compensate for this effect.

Accordingly, one has access to the usually unknown number of particles that are participating in the binding process at a certain sensor. This number in general depends on a variation in dissolving the dry particles and the speed of dissolving. Further reasons for variation are misalignment of the actuation magnet with respect to the sensor chip and/or an inhomogeneous magnetic field gradient.

In case of an inhibition process, one is interested in the number participating in the inhibition process, i.e. the total number of particles in the sample volume. If several sensors n are present, one may calculate the number of particles per sensor xᵢ+yᵢ for each sensor i as described above and then add these numbers in order to get the total number X+Y of particles in the sample volume: X+Y=x₁+y₁+x₂+y₂+ . . . +xₙ+yₙ. The larger the number of sensors n the more accurate the estimate for the total number of particles will be.

The variation in the number of particles at different sensors could also generate an extra correction factor for the inhibition per sensor. At the moment we assume that the diffusion of the small target molecules is fast enough to neglect this phenomenon, but future experiments will show the validation of this assumption. Even when an extra correction factor is not needed, this spatial particle number variation can be used as a sort of reliability check of the test. All measurements can be used as a sort of reliability check of the test. If the total number of particles at a certain sensor is very low, it can make the test very unreliable.

Of course, the method described in the present invention, although described with respect to an FTIR sensor, is not restricted to FTIR. The sensor can be any suitable sensor to detect the presence of magnetic particles on or near to a sensor surface, based on any property of the particles, e.g. it can detect via magnetic methods (e.g. magnetoresistive, Hall, coils), optical methods (e.g. imaging, fluorescence, chemiluminescence, absorption, scattering, evanescent field techniques, surface plasmon resonance, Raman, etc.), sonic detection (e.g. surface acoustic wave, bulk acoustic wave, cantilever, quartz crystal etc), electrical detection (e.g. conduction, impedance, amperometric, redox cycling), combinations thereof, etc.

If other sensors are used, certain measures may be taken for a specific implementation. For instance, in case of magneto-resistive sensors, usually current wires are used in order to generate a magnetic field, which induces a dipole in the super-paramagnetic particles, whose dipole field may then be measured with a magneto-resistive sensor. These current wires cause a lateral up-concentration of particles. Up-concentration occurs only for the unbound particles, which means that the number of measured unbound particles is too high with respect to the bound particles. Therefore, an up-concentration factor A, which is 1 without up-concentration, is added to the method.

In addition to molecular assays, also larger moieties may be detected, e.g. cells, viruses, or fractions of cells or viruses, tissue extract, etc. The detection can occur with or without scanning of the sensor element with respect to the biosensor surface. Measurement data can be derived as an end-point measurement, as well as by recording signals kinetically or intermittently. The label particles can be detected directly by the sensing method. As well, the particles can be further processed prior to detection. An example of further processing is that materials are added or that the (bio)chemical or physical properties of the label particles are modified to facilitate detection. The method according to the present invention can be used with several biochemical assay types, e.g. binding/unbinding assay, sandwich assay, competition assay, displacement assay, enzymatic assay, etc. The methods of this invention are suited for sensor multiplexing (i.e. the parallel use of different sensors and sensor surfaces), label multiplexing (i.e. the parallel use of different types of labels) and chamber multiplexing (i.e. the parallel use of different reaction chambers). The methods described in the present invention can be used as rapid, robust, and easy to use point-of-care biosensors for small sample volumes. The reaction chamber can be a disposable item to be used with a compact reader, containing the one or more magnetic field generating means and one or more detection means. Also, the methods of the present invention can be used in automated high-throughput testing. In this case, the reaction chamber is e.g. a well plate or cuvette, fitting into an automated instrument.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. Method of measuring the concentration of predetermined molecules in a sample fluid comprising the following steps:
a) adding the sample fluid to a cartridge in which label particles are present, such that the label particles can interact with the fluid, wherein the label particles are adapted to capture said predetermined molecules and to bind to a sensor surface of said cartridge;
b) allowing the label particles to interact with the sensor surface;
c) measuring the amount of label particles close to the sensor surface;
d) removing label particles, which are not bound to the sensor surface; and
e) measuring the amount of label particles close to the sensor surface.

2. Method according to claim 1, further comprising the step of processing the results of steps c) and e) and calculating the concentration of said predetermined molecules in the sample fluid.

3. Method according to claim 1, further comprising the step of calculating the amount of bound and unbound label particles.

4. Method according to claim 1, wherein the amount of label particles close to the sensor surface is measured by FTIR.

5. Method according to claim 1, wherein the label particles are super-paramagnetic.

6. Method according to claim 5, wherein step b) is accelerated by magnetic actuation of the label particles towards the sensor surface.

7. Method according to claim 5, wherein the amount of label particles close to the sensor surface is measured by measuring the magnetic stray field of the label particles with a magneto-resistive sensor.

8. Method according to claim 5, wherein the label particles, which are not bound to the surface, are removed by a magnetic field.

9. Method according to claim 1, wherein step c) is performed at several specific binding spots of the sensor surface, and subsequently step e) is performed at several specific binding spots of the sensor surface.

10. Method according to claim 1, wherein steps c) and e), respectively, take place simultaneously at several specific binding spots of the sensor surface.

11. Method according to claim 9, further comprising the step of calculating the amount of bound and unbound label particles for each binding spot.

12. Method according to claim 1, wherein the label particles bind to the sensor surface only, if said molecules are being captured.

13. Method according to claim 1, wherein the label particles bind to the sensor surface only, if no molecules are being captured.
